(19) United States
(12) Patent Application Publication
(10) Pub. No.: US 2010/0020181 A1
(43) Pub. Date: Jan. 28, 2010

(54) INFORMATION PROCESSING APPARATUS AND INFORMATION PROCESSING METHOD

(75) Inventor: Kazuto Kuroda, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/962,882

(22) Filed: Dec. 21, 2007

(30) Foreign Application Priority Data
Dec. 26, 2006 (JP) 2006-350330

(51) Int. Cl. H04N 5/225

(52) U.S. Cl. 348/207.1; 348/E05.024

(57) ABSTRACT

In an information processing apparatus according to the present invention, a control unit obtains identification information identifying an information device connected to the information processing apparatus, determines compatibility based upon the identification information and a prestored list table of compatible information devices, and writes information that is recorded in advance to the information device to a disc when it is determined that the information device is compatible with the information processing apparatus.

### BACKGROUND OF THE INVENTION

1. Field of the Invention

The present invention relates to an information processing apparatus and an information processing method. In particular, the present invention relates to an information processing apparatus and an information processing method that records, to a disc, information stored in an information device connected thereto.

2. The Related Art

A camera-integrated video recorder (so-called camcorder) and a digital steel camera having a compact HDD or a nonvolatile semiconductor memory (e.g., flash memory (registered trademark)) as an information storage (recording) medium are rapidly widespread.

The camera-integrated video recorder and digital camera need to transfer image data via a personal computer to a large-capacity recording medium (an internal recording medium such as a fixing HDD, or an external recording medium such as an optical disc and a magneto-optical disc) every shooting for some time so as to store (record) a large capacity of image data or music data (audio data) to another compact HDD or nonvolatile semiconductor memory serving as an information storage (recording) medium having a limited capacity.

Incidentally, one of technologies for transferring the image data or music data recorded (stored) to the camera-integrated video recorder or digital camera to another device is well-known to use data by directly connecting devices without depending on a maker and a type of devices (refer to e.g., Japanese Unexamined Patent Application Publication No. 2004-328544).

However, with the conventional art, upon transferring via a personal computer the image data or music data recorded (stored) to the camera-integrated video recorder or digital camera to an external recording medium, such as an optical disc, with low costs per bit, preferable to storage and distribution, there is generally a problem that a user who is inexperienced to the use of the personal computer cannot perform a series of operations because complicated operation is required for the transfer.

Further, even if transferring via the personal computer the image data or music data recorded (stored) to the camera-integrated video recorder or digital camera to the external recording medium, such as an optical disc, only the image data or music data is moved between the devices. For example, an optical disc play-only device (an optical disc reading-dedicated device) does not have navigation data (i.e., data for creating a menu screen) necessary for reproducing the data, and there is thus a problem that the optical disc play-only device cannot reproduce the data.

Recently, a dedicated device is proposed to record the image data or music data recorded to the camera-integrated video recorder to the optical disc in a format capable of reproduction by an optical disc play-only device. However, this is not for general use and is not used for any devices other than the camera-integrated video recorder.

As mentioned above, with the conventional art, various information stored to various portable digital information devices such as a camera-integrated video recorder, digital steel camera, and mobile phone, cannot be recorded to the optical disc with only one device, not via the personal computer in a format capable of reproduction by even the optical disc play-only device.

The problems cannot be solved even with the technology proposed in Publication No. 2004-328544.

### SUMMARY OF THE INVENTION

The present invention is devised in consideration of the above situation. It is an object of the present invention to provide an information processing apparatus and an information processing method that improve the convenience upon storing and managing information stored to various information devices.

In order to solve the above problem, an information processing apparatus according to the present invention comprises: an obtaining unit configured to obtain identification information for identifying an information device connected to the information processing apparatus from the information device; a determining unit configured to determine whether or not the information device is an information device compatible with the information processing apparatus on the basis of the identification information obtained by the obtaining unit with reference to a list table of compatible information devices prestored; and a first writing unit configured to write information recorded in advance to the information device to a disc when it is determined by the determining unit that the information device is the information device compatible with the information processing apparatus.

In order to solve the above problem, an information processing method of an information processing apparatus according to the present invention comprises: an obtaining step of obtaining identification information for identifying an information device connected to the information processing apparatus from the information device; a determining step of determining whether or not the information device is an information device compatible with the information processing apparatus on the basis of the identification information obtained by the obtaining unit with reference to a list table of compatible information devices prestored; and a first writing step of writing information recorded in advance to the information device to a disc when it is determined by processing in the determining step determines that the information device is the information device compatible with the information processing apparatus.

With the information processing apparatus according to the present invention, the identification information for identifying the information device is obtained from the information device connected to the information processing apparatus. It is determined whether or not the information device is compatible with the information processing apparatus on the basis of the obtained identification information with reference to a pre-stored list table of compatible information devices. When it is determined that the information device compatible with the information processing apparatus, the information that is recorded in advance to the information device is written to the disc.

With the information processing method of the information processing apparatus according to the present invention, the identification information for identifying the information device is obtained from the information device connected to the information processing apparatus. It is determined whether or not the information device compatible with the information processing apparatus on the basis of the obtained identification information with reference to a pre-stored list table of compatible information devices. When it is determined that the information device compatible with the information processing apparatus, the information that is recorded in advance to the information device is written to the disc.

According to the present invention, it is possible to improve the convenience upon storing and managing the information stored to various information devices.

### BRIEF DESCRIPTION OF THE DRAWINGS

FIG. 1 is an external view showing the external structure of an information processing apparatus according to the first embodiment of the present invention;

FIG. 2 is a block diagram showing the internal structure of the information processing apparatus according to the first embodiment of the present invention;

FIG. 3 is a flowchart for illustrating disc creating processing in the information processing apparatus shown in FIG. 2;

FIG. 4 is a flowchart for illustrating the details of data transfer processing in step S6 of FIG. 3;

FIG. 5 is a diagram showing one example of a display shown in FIG. 2;

FIG. 6 is a diagram showing another example of the display shown in FIG. 2;

FIG. 7 is a diagram showing another example of the display shown in FIG. 2.

FIG. 8 is a flowchart for illustrating the details of backup processing in step S35 of FIG. 4;

FIG. 9 is a flowchart for illustrating the details of restoring processing in step S51 of FIG. 8;

FIG. 10 is a block diagram showing the internal structure of an information processing apparatus according to the second embodiment of the present invention;

FIG. 11 is a flowchart for illustrating the details of backup processing in the information processing apparatus shown in FIG. 10;

FIG. 12 is a flowchart for illustrating the details of restoring processing in step S94 of FIG. 11;

FIG. 13 is a diagram showing another example of the display shown in FIG. 2; and

FIG. 14 is a block diagram showing the internal structure of an information processing apparatus according to the third embodiment of the present invention.

### DESCRIPTION OF THE PREFERRED EMBODIMENTS

Hereinbelow, a description will be given of embodiments of the present invention with reference to the drawings.

### First Embodiment

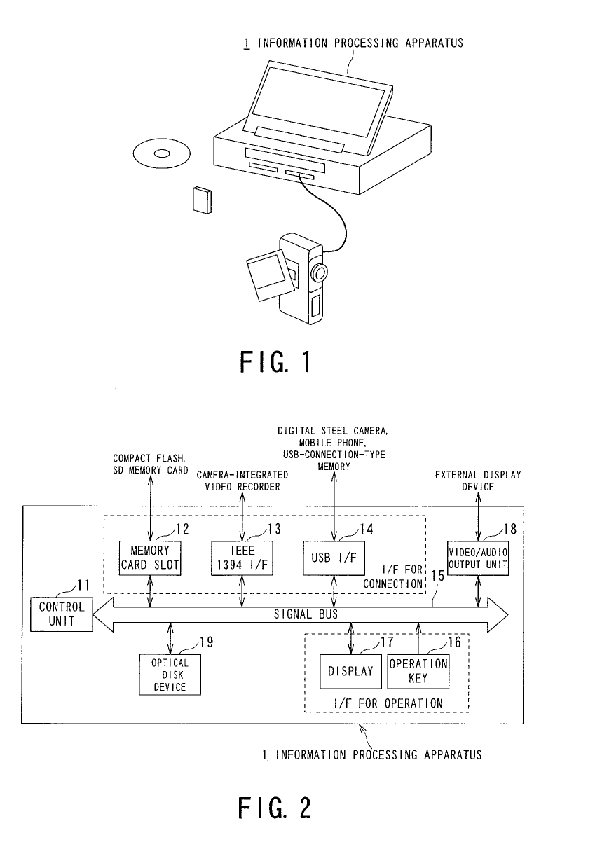

FIG. 1 shows the structure of the external view of an information processing apparatus 1 according to the first embodiment of the present invention.

Connected to an information processing apparatus 1 is a devices, various memory cards such as a compact flash (registered trademark) and an SD memory card (registered trademark), a storage device, typically, e.g., a movable fixed disc apparatus, a camera-integrated video recorder, a digital steel camera, or a device, typically, e.g., a mobile phone. Further, the information processing apparatus 1 includes an optical disc device, an optical disc can be properly inserted or removed to/from the information processing apparatus 1.

FIG. 2 shows the interval structure of the information processing apparatus 1 according to the first embodiment of the present invention.

Referring to FIG. 2, the information processing apparatus 1 comprises: a control unit 11; a memory card slot 12; an IEEE (the Institute of Electrical and Electronics Engineers) 1394 interface (I/F) 13; a USB interface (I/F) 14; a signal bus 15; an operation key 16; a display 17; a video/audio output unit 18; and an optical disc device 19.

The control unit 11 comprises a CPU, a ROM, and a RAM. The CPU executes various processing in accordance with a program stored in the ROM or various application programs loaded to the RAM. Further, the CPU creates various control signals and supplies the created signals, thereby systematically controlling the information processing apparatus 1. The RAM properly stores data necessary for executing various processing by the CPU.

An interface for connection comprises, e.g., the memory card slot 12, the IEEE 1394 I/F 13, and the USB I/F 14. As a consequence, various memory cards such as a compact flash and an SD memory card (both area registered trademarks) can be connected to the information processing apparatus 1 via the memory card slot 12, and a camera-integrated video recorder can be connected to the information processing apparatus 1 via the IEEE 1394 I/F 13. Further, a digital steel camera, a mobile phone, or a USB-connection-type nonvolatile semiconductor memory can be connected to the information processing apparatus 1 via the USB I/F 14.

As an interface for operation operated by the user, e.g., the operation key 16 and the display 17 (e.g., LCD) are arranged. Depending on conditions, in place of the operation key 16, a remote controller (not shown) may be used and, alternatively, in place of the display 17, a touch panel (not shown) may be used. Further, the video/audio output unit 18 is arranged to the information processing apparatus 1 and may be connected to an external display device (not shown) (e.g., a TV receiver).

The optical disc device 19 writes the image data or music data read via the interface for connection, such as the memory card slot 12 to an optical disc (not shown), under the control of the control unit 11, thereby recording the image data or music data.

Incidentally, various memory cards including a compact flash and an SD memory card (both are registered trademarks), a storage device, typically, e.g., a movable fixed disc apparatus, a camera-integrated video recorder, a digital steel camera, and a device, typically, e.g., a mobile phone are generically referred to as a “portable digital information device”.

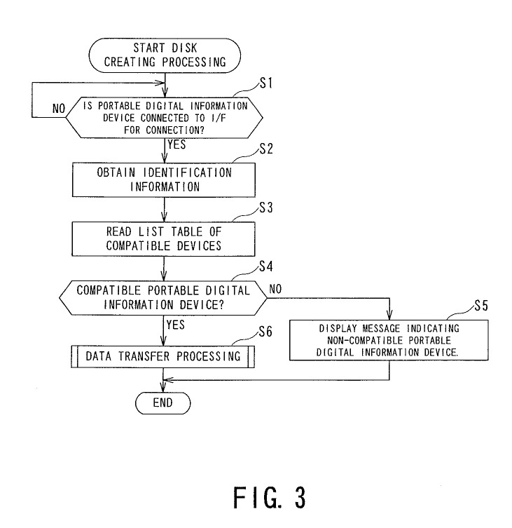

Next, a description will be given of disc creating processing in the information processing apparatus 1 shown in FIG. 2 with reference to a flowchart shown in FIG. 3. The disc creating processing starts when the user connects the portable digital information device such as a digital steel camera or a camera-integrated video recorder to the information processing apparatus 1.

In step S1, the user operates the portable digital information device such as a digital steel camera or a camera-integrated video recorder. Accordingly, the control unit 11 determines, via the signal bus 15, whether or not the portable digital information device is connected to the interface for connection (the memory card slot 12, etc.) of the information processing apparatus 1. The operation is waited until the control unit 11 determines that the portable digital information device is connected to the interface for connection (the memory card slot 12, etc.) of the information processing apparatus 1.

If it is determined in step S1 that the portable digital information device is connected to the interface for connection (the memory card slot 12, etc.) of the information processing apparatus 1, in step S2, the control unit 11 obtains identification information for identifying the portable digital information device via the signal bus 10 from the portable digital information device connected to the information processing apparatus 1 via the interface for connection (the memory card slot 12, etc.).

If connecting the portable digital information device (e.g., the camera-integrated video recorder, digital steel camera, or mobile phone) to the information processing apparatus 1 via the IEEE 1394 I/F 13 or USB I/F 14, identification code determined by a connection protocol for each portable digital information device is obtained as the identification information. The identification code includes data on a product name or product number of the portable digital information device connected to the information processing apparatus 1.

Further, if the portable digital information device (e.g., a memory card) is connected to the information processing apparatus 1 via the memory card slot 12, information on card contents (e.g., file structure) of the mobile digital information device is obtained as the identification information.

Obviously, the identification information obtained in step S2 may be information for identifying which device is the portable digital information device connected to the information processing apparatus 1.

In step S3, the control unit 11 reads a list table of compatible information devices, stored in advance to the ROM or RAM in the control unit 11.

In step S4, the control unit 11 determines on the basis of the obtained identification information by referring to the read list table of compatible information devices, whether or not the connected portable digital information device is a portable digital information device compatible with the information processing apparatus 1.

If it is determined in step S4 that the connected portable digital information device is not a mobile digital information device compatible with the information processing apparatus 1, in step S5, the control unit 11 enables, via the signal bus 15, the display 17 to display a message indicating that the portable digital information device connected to the information processing apparatus 1 is a portable digital information device that is not compatible with the information processing apparatus 1. The display 17 displays the message indicating that the portable digital information device connected to the information processing apparatus 1 is the portable digital information device that is not compatible with the information processing apparatus 1, under the control of the control unit 11.

The display 17 displays a message indicating that “this device is not compatible with the apparatus.” Obviously, the display 17 may display an icon indicating that the portable digital information device is the portable digital information device that is not compatible with the apparatus.

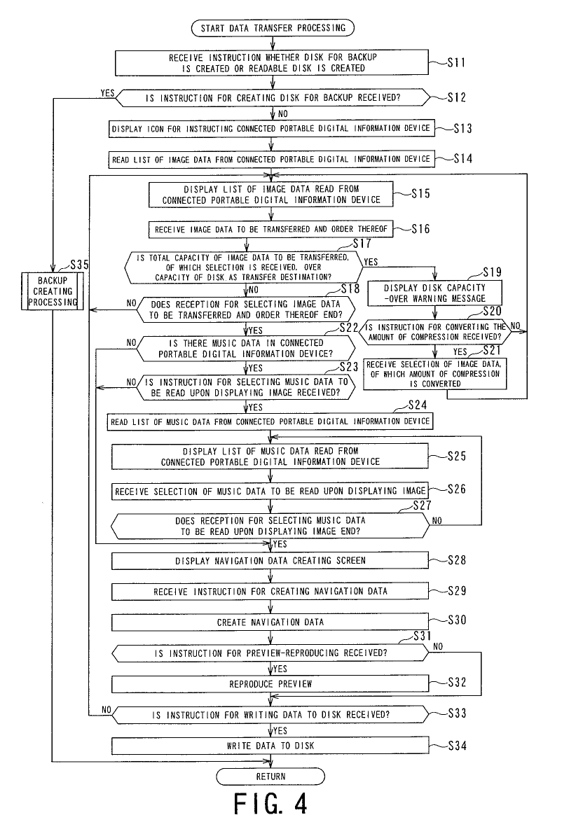

If it is determined in step S4 that the connected portable digital information device is the portable digital information device compatible with the information processing apparatus 1, in step S6, the control unit 11 executes data transfer processing. The details of the data transfer processing will be shown with reference to a flowchart of FIG. 4.

A description will be given of the details of the data transfer processing in the information processing apparatus 1 shown in FIG. 2 with reference to a flowchart of FIG. 4.

In step S11, the user operates the operation key 16 for operation I/F via the signal bus 15 on the operation screen, and the control unit 11 thus receives an instruction indicating whether an optical disc for backup is created to backup the information (image data and music data) recorded (stored) to the connected portable digital information device or an optical disc readable by an optical disc play-only device is created with the information (image data and music data) recorded (stored) to the connected mobile digital information device.

As a consequence, it is possible to set the type of the optical disc (e.g., the optical disc for backup) as the transfer destination for transferring the information (image data and music data) recorded (stored) to the connected portable digital information device or the optical disc readable by the optical disc play-only device).

In step S12, the control unit 11 determines, via the signal bus 15, whether or not the instruction for creating the optical disc for backup is received so as to backup the information (image data and music data) recorded (stored) to the connected portable digital information device.

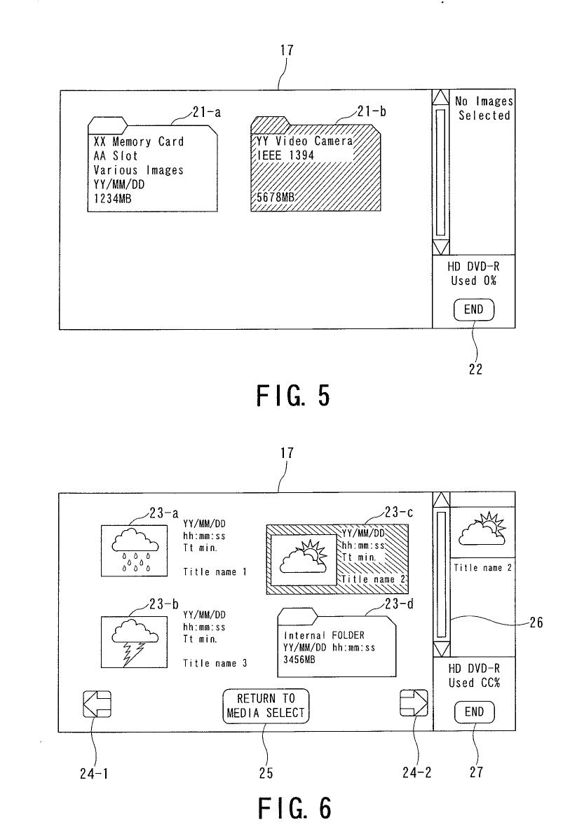

In step S12, it is determined that the instruction for creating the optical disc for backup so as to backup the information (image data and music data) recorded (stored) to the connected portable digital information device (in other words, the instruction for creating the optical disc readable by the optical disc play-only device with the information (image data and music data) recorded (stored) to the connected portable digital information device is not received), in step S13, the control unit 11 enables the display 17 to display an icon instructing the connected portable digital information device. As shown in FIG. 5, the display 17 displays the icon instructing the connected portable digital information device.

In the example shown in FIG. 5, a plurality of portable digital information devices are connected to the information processing apparatus 1, and the display 17 displays icons 21-a and 21-b instructing a plurality of portable digital information devices.

The icon 21-a indicates that a memory card called “XX Memory Card” is connected to the memory card slot 12 called “AA Slot” as a name of a connection I/F. Further, the icon 21-a indicates that the memory card stores image data with “1234 MB” capacity created at date and time of “YY/MM/DD”.

Further, the icon 21-b indicates that the camera-integrated video recorder called “YY Video Camera” is connected to the IEEE 1394 I/F 13.

In step S14, the user operates the operation key 16 for operation I/F so as to select the icon (e.g., the icon 21-a or 21-b) on the display screen displayed on the display 17 shown in FIG. 5. Thus, the control unit 11 reads a list of the image data (moving image data and still image data) recorded (stored) to the connected portable digital information device (the portable digital information device instructed by the icon selected by the user).

The user operates the operation key 16 for operation I/F so as to select the icon 21-b on the display screen displayed on the display 17 shown in FIG. 5, thereby reading the list of the image data (moving image data and still image data) recorded (stored) to the camera-integrated video recorder called “YY Video Camera”, instructed by the icon 21-b.

In step S15, the control unit 11 obtains, via the signal bus 15, the list of the image data read from the connected portable digital information device, and enables the display 17 to display the obtained list of the image data. As shown in FIG. 6, the display 17 displays the list of the image data read from the connected portable digital information device under the control of the control unit 11.

In the example shown in FIG. 6, the display 17 displays icons 23-a, 23-b, 23-c, and 23-d for instructing the image data (moving image data and still image data) read from the portable digital information device of which selection is received by the user, and further displays command icons 24-1 to 24-2, 25, 26, and 27 indicating various commands.

The icons 23-a, 23-b, and 23-c indicate that the image data is recorded (stored) to the portable digital information device of which selection is received by the user. If the image data is still image data, the icons (e.g., the icons 23-a, 23-b, and 23-c) indicate the still image (thumbnail displayed), creating date and time, a message that the image data is still image, and a title (only if the title exists). On the other hand, if the image data is moving image data, the icon (e.g., the icons 23-a, 23-b, and 23-c) indicates only the head still image (the still image based on the still image data in one frame from the moving image data is thumbnail displayed), creating date and time, the shooting time, and a title (only if the title exists). Incidentally, if the image data is moving image data, e.g., the icon 23-c is selected by the user, the moving image data instructed by the icon 23-c.

Incidentally, if the list of the image data read from the connected portable digital information device is not displayed once on the display 17, the user operates the operation key 16 of the operation I/F, thereby operating the command icons 24-1 and 24-2 on the display 17. Accordingly, the list of the image data read from the connected portable digital information device is sequentially displayed.

In step S16, the user operates the operation key 16 for operation I/F, and the control unit 11 thus receives, via the signal bus 15, the image data to be transferred to the optical disc and the order thereof.

In the example shown in FIG. 6, the selection of the icons 23-a and 23-b is received and the order (e.g., first or second) upon recording the image data to the optical disc is simultaneously received.

Obviously, at this time, all image data read from the connected portable digital information device can be designated in a lump.

In step S17, the control unit 11 determines whether or not the total capacity of the image data to be transferred to the optical disc of which selection is received is over the capacity of the optical disc as the transfer destination.

If it is determined in step S17 that the total capacity of the image data to be transferred to the optical disc of which selection is received is not over the capacity of the optical disc as the transfer destination, in step S18, the control unit 11 determines whether or not the reception for selecting the image data to be transferred to the optical disc and the order thereof ends.

Specifically, in the example shown in FIG. 5, the user operates the operation key 16 and the selection of the command icon 22 for instructing a command (instruction) “END” is thus received. Then, it is determined that the reception for selecting the image data to be transferred to the optical disc and the order thereof end.

If it is determined in step S18 that the reception for selecting the image data to be transferred to the optical disc and the order thereof does not end, the processing returns to step S15 and the processing after step S15 is iteratively executed. As a consequence, until issuing an instruction for ending the reception for selecting the image data to be transferred to the optical disc and the order thereof, the user can iteratively execute the selection of the image data to be transferred to the optical disc and the order thereof.

If it is determined in step S17 that the total capacity of the image data to be transferred to the optical disc of which selection is received is over the capacity of the optical disc, in step S19, the control unit 11 enables, via the signal bus 15, the display 17 to display an over-disc-capacity warning message, serving as a message for warning that the image data is over the capacity of the optical disc as the transfer destination. The display 17 displays the over-disc-capacity warning message serving as the message for warning that the image data is over the capacity of the optical disc as the transfer destination under the control of the control unit 11.

The display 17 displays the over-disc-capacity warning message, e.g., “Disc is full”.

In this case, by compressing the amount of the image data to be transferred to the optical disc, it is possible to change the total capacity of the image data to be transferred to the optical disc. As a result, the total capacity can be reduced. Then, an instruction for converting the amount of compressing the image data to be transferred is received from the user.

In step S20, the user operates the operation key 16 for operation I/F, and the control unit 11 thus determines whether or not the instruction for converting the amount of compressing the image data to be transferred is received.

If it is determined in step S20 that the instruction for converting the amount of compressing the image data to be transferred is not received, the processing returns to step S15, and the processing after step S15 is iteratively executed.

On the other hand, if it is determined in step S20 that the instruction for converting the amount of compressing the image data to be transferred is received, in step S21, the user operates the operation key 16 for operation I/F, and the control unit 11 thus receives the selection of image data for conversion of the amount of compression from among the image data to be transferred.

Subsequently, the processing advances to step S15, and the processing after step S15 is iteratively executed.

On the other hand, if it is determined in step S18 that the reception for selecting the image data to be transferred to the optical disc and the order thereof ends, in step S22, the control unit 11 determines whether or not there is music data in the connected digital information device.

If it is determined in step S22 that there is music data in the connected digital information device, in step S23, the user operates the operation key 16 for operation I/F, and the control unit 11 thus determines whether or not the instruction for selecting the music data to be reproduced on the background upon displaying the image is received.

If it is determined in step S23 that the instruction for selecting the music data to be reproduced on the background upon displaying the image is received, in step S24, the control unit 11 reads a list of the music data recorded (stored) to the connected portable digital information device.

In step S25, the control unit 11 enables, via the signal bus 15, the display 17 to display the read list of the music data recorded (stored) to the portable digital information device. The display 17 displays the list of the music data recorded (stored) to the portable digital information device under the control of the control unit 11.

In step S26, the user operates the operation key 16 for operation I/F, and the control unit 11 thus receives the selection of the music data to be reproduced on the background upon displaying the image.

For example, the selection of the music data to be reproduced on the background upon displaying the image is received from among the list of the music data recorded (stored) to the connected portable digital information device displayed on the display 17. At this time, an output level of sound (music) of the music data can be set and the addition of an echo effect to the music data can be set.

In step S27, the control unit 11 determines whether or not the reception for selecting the music data to be reproduced on the background upon displaying the image ends. If it is determined in step S27 that the reception for selecting the music data to be reproduced on the background upon displaying the image does not end, the processing returns to step S25 and the processing after step S25 is iteratively executed.

If it is determined in step S27 that the reception for selecting the music data to be reproduced on the background upon displaying the image ends, the processing advances to step S28.

On the other hand, if it is determined in step S22 that there is not music data in the connected digital information device, the processing in steps S23 to S27 is skipped. That is, the processing for receiving the selection of the music data to be reproduced on the background upon displaying the image is not performed.

Further, if it is determined in step S23 that the instruction for selecting the music data to be reproduced on the background upon displaying the image is not received, the processing in steps S24 to S27 is also skipped. That is, the processing for receiving the selection of the music data to be reproduced on the background upon displaying the image is not performed.

In step S28, the control unit 11 enables the display 17, via the signal bus 15, to display a screen for creating navigation data (i.e., data for creating a menu screen) necessary for reproducing the image data to be transferred to the optical disc in the optical disc play-only device. The display 17 displays the screen for creating the navigation data (i.e., data for creating the menu screen) necessary for reproducing the image data to be transferred to the optical disc, under the control of the control unit 11.

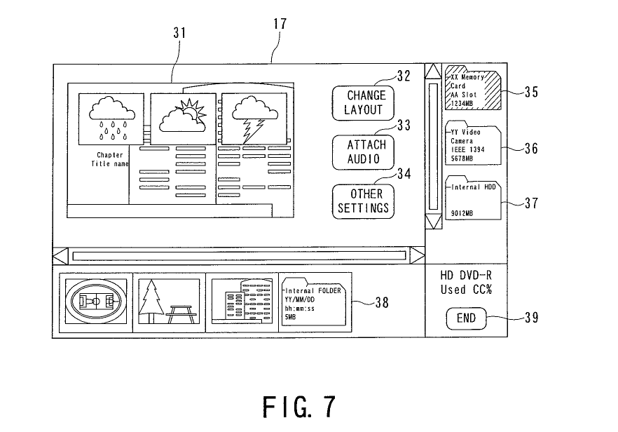

For example, the display 17 displays the screen for creating the navigation data shown in FIG. 7. On the screen for creating the navigation data, e.g., it is selected whether or not there is a title screen in the reproducing of the image data and, whether or not the still image displayed on the title screen in the reproducing is selected, and whether or not the design of video thumbnail display is created on a chapter selecting screen in the reproducing. Further, upon selecting the still image displayed on the title screen in the reproducing, reproducing control information is created, on whether the image is shifted to the next one after a predetermined time or the image is shifted after the user instructs an instruction for shifting the image to the next one.

In the case of shown in FIG. 7, at an area on the left side of the screen for creating the navigation data, the created chapter selecting screen 31 is displayed. At an area on the right side of the chapter selecting screen 31, a command icon 32 is displayed to instruct the shift to a selection screen for determining whether the list of chapters is arranged longitudinally or laterally, and further determining whether only a character is displayed or a character and an image are displayed.

Furthermore, the chapter selecting screen 31 displays, on the right side, a command icon 33 for instructing the shift to a selection screen for selecting the music data to be reproduced on the chapter selecting screen, and a command icon 34 for instructing the shift to a selecting screen for selecting whether or not the chapter selecting screen is added and whether the chapter selecting screen is displayed at the first time of the reproducing or the chapter selecting screen is displayed later.

In addition, on the right side of the command icons 32 to 34, a scroll bar (scroll bar for up/down scroll) is arranged. Moreover, on the right thereof, icons 35 to 37 for instructing the connected portable digital information device to the information processing apparatus 1 are displayed. Incidentally, below the chapter selecting screen 31, a scroll bar (scroll bar for left/right scroll) is arranged. Moreover, below this, a selecting screen is displayed to select a background image of the chapter selecting screen.

In step S29, the user operates the operation key 16 for operation I/F, and the control unit 11 thus receives an instruction (selection, etc.) for creating the navigation data on the screen for creating the navigation data.

On the screen for creating the navigation data shown in FIG. 7, various instructions (selection, etc.) for creating the navigation data are received.

In step S30, the control unit 11 creates the navigation data on the basis of the instruction for instructing the navigation data received on the screen for creating the navigation data.

In step S31, the user operates the operation key 16 for operation I/F, and the control unit 11 thus determines whether or not an instruction for preview reproducing to check the situation upon reproducing the navigation data created by the above operation is received.

If it is determined that in step S31 that the instruction for preview reproducing to check the situation upon reproducing the navigation data created by the above operation is received, the control unit 11 controls, via the signal bus 15, the display 17 to reproduce the preview for checking the situation upon reproducing the navigation data created by the above operation.

Upon reproducing the preview at this time, the user operates the operation key 16 for operation I/F, thereby instructing stop, restart, fast-feed, and fast-return at an arbitrary timing.

If it is determined that in step S31 that the instruction for preview to check the situation upon reproducing the navigation data created by the above operation is not received, the processing for reproducing the preview in step S32 is skipped.

In step S33, the user operates the operation key 16 for operation I/F, and the control unit 11 thus determines whether or not an instruction for writing the navigation data and the image data to be transferred to the optical disc is received.

If it is determined in step S33 that the instruction for writing the navigation data and the image data to be transferred to the optical disc is not received, the processing returns to step S15. Thereafter, the processing after step S15 is similarly repeated. As a consequence, when the user wants to change or correct the contents upon reproducing the preview, he/she can enable the information processing apparatus 1 to iteratively execute the similar processing until obtaining desired contents.

If it is determined in step S33 that the instruction for writing the navigation data and the image data to be transferred to the optical disc is received, prior to the data transfer to the optical disc, the control unit 11 recognizes, via the signal bus 15, whether or not a predetermined optical disc is inserted into the optical disc device 19. If it is recognized that the predetermined optical disc is not inserted into the optical disc device 19, the control unit 11 enables the display 17 to display a message indicating that “Insert the optical disc into the optical disc device 19”.

If it is recognized that the predetermined optical disc is inserted into the optical disc device 19, the control unit 11 reads, via the signal bus 15, necessary data from the connected portable digital information device, and controls the optical disc device 19 to write the image data to be transferred and the navigation data (including the reproducing control information) to the optical disc. The optical disc device 19 writes the image data to be transferred and the navigation data under the control of the control unit 11.

At this time, the control unit 11 develops and re-compresses the image data having the changed compressing ratio of the image data in the data transfer or the image data in a compressing format in which the data is not reproduced in the play-only device for reproducing the optical disc, and thereafter executes the writing processing to the optical disc.

Further, if the image data to be transferred to the optical disc includes image data of which copyright is protected, the image data is transferred within an available range of the image data having the copyright. Specifically, only when the data shift is possible depending on the available range, the data is transferred to the optical disc in accordance with the situations, e.g., the data shift is possible until a preset number of times. As needed, the deletion of the image data on the transfer source is executed.

Incidentally, when the optical disc device writes, to the optical disc, the image data to be transferred and the navigation data (including the reproducing control information), the situation of the data transfer is displayed on the display 17, e.g., bar graph indication and numeral display of estimated end time. As a consequence, the user can know the situation of the current data transfer to the optical disc. Further, upon ending the data transfer to the optical disc, such a message may be informed to the user with sound generated by a speaker or buzzer (not shown).

Thereafter, the processing returns to a flowchart shown in FIG. 3, and the disc creating processing ends.

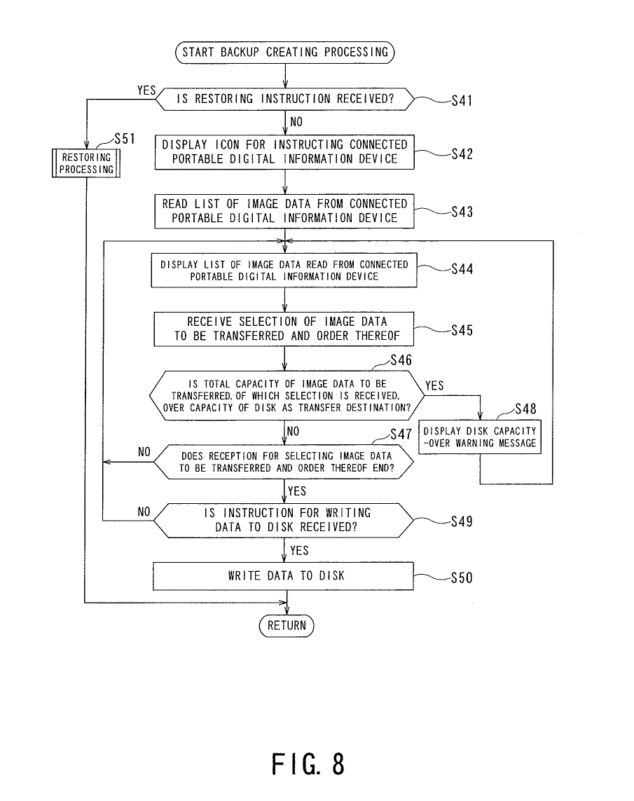

On the other hand, it is determined in step S12 that the instruction for creating the optical disc for backup for backuping the information (image data and music data) recorded (stored) to the connected portable digital information device, in step S35, the control unit 11 executes backup creating processing. The details of the backup creating processing are shown in a flowchart of FIG. 8.

A detailed description will be given of the backup creating processing with the information processing apparatus 1 shown in FIG. 2 with reference to a flowchart shown in FIG. 8.

In step S41, the user operates the operation key 16 for operation I/F, and the control unit 11 thus determines whether or not an instruction for restoring the data (moving image data, still image data, music data, etc.) recorded to the portable digital information device connected to the information processing apparatus 1 to another portable digital information device is received.

If it is determined in step S41 that the instruction for restoring the data (moving image data, still image data, music data, etc.) recorded (stored) to the portable digital information device connected to the information processing apparatus 1 to another portable digital information device is not received, (i.e., the instruction for backuping, to the optical disc, the data (moving image data, still image data, music data, etc.) recorded (stored) to the portable digital information device connected to the information processing apparatus 1), in step S42, the control unit 11 enables, via the signal bus 15, the display 17 to display the icon for instructing the connected portable digital information device. The display 17 displays the icon for instructing the connected portable digital information device under the control of the control unit 11, as shown in FIG. 5. Incidentally, the description of FIG. 5 is basically the same as the contents described in step S13 of FIG. 4, and is omitted so as to prevent the repetition.

In step S43, the user operates the operation key 16 for operation I/F, the icon (e.g., the icons 21-a or 21-b) on the display screen of the display 17 shown in FIG. 5 is selected, and the control unit 11 thus reads the list of the image data (moving image data and still image data) recorded (stored) to the connected portable digital information device (the portable digital information device instructed by the icon selected by the user).

In step S44, the control unit 11 obtains, via the signal bus 15, the list of the image data read from the connected portable digital information device, and enables the display 17 to the obtained list of the image data. The display 17 displays the list of the image data read from the connected portable digital information device under the control of the control unit 11, as shown in FIG. 6. Incidentally, the description of FIG. 6 is basically the same as the contents described in step S15 of FIG. 4, and is omitted so as to prevent the repetition.

In step S45, the user operates the operation key 16 for operation I/F, and the control unit 11 receives, via the signal bus 15, the selection of the image data to be transferred to the optical disc and of the order thereof.

In the case of FIG. 6, it is possible to receive the selection of the icon 23-a or 23-b is received and the selection of the order (e.g., first or second) upon recording the data to the optical disc. Obviously, at this time, it is possible to designate all the image data in a lump read from the connected portable digital information device.

Incidentally, at this time, data encryption can be instructed to encrypt and record the data in the backup. As a consequence, only if a password of which input is received to a password input receiving column (not shown) matches a preset password upon reproducing or transferring (recording) the optical disc of which data is transferred, the data can be transferred and be backuped in a format for preventing the decryption of meaningful data.

In step S46, the control unit 11 determines whether or not the total capacity of the image data to be transferred to the optical disc as the transfer destination, of which selection is received, is over the capacity of the optical disc.

If it is determined in step S46 that the total capacity of the image data to be transferred to the optical disc as the transfer destination, of which selection is received, is not over the capacity of the optical disc, in step S47, the control unit 11 determines whether or not the reception for selecting the image data to be transferred to the optical disc and the order thereof ends.

If it is determined in step S47 that the reception for selecting the image data to be transferred to the optical disc and the order thereof does not end, the processing returns to step S44 and the processing after step S44 is iteratively executed. As a consequence, the user can iteratively execute the selection of the image data to be transferred to the optical disc and the order thereof until instructing the end of the reception for selecting the image data to be transferred to the optical disc and the order thereof.

On the other hand, if it is determined in step S46 that the total capacity of the image data to be transferred to the optical disc as the transfer destination, of which selection is received, is over the capacity of the optical disc, in step S48, the control unit 11 enables, via the signal bus 15, the display 17 to a disc capacity-over warning message serving as a message for warning that the data is over the capacity of the disc as the transfer destination. Under the control of the control unit 11, the display 17 displays the disc capacity-over warning message serving as a message for warning that the data is over the capacity of the disc as the transfer destination.

The display 17 displays the disc capacity-over warning message, e.g., “Disc is full”.

If it is determined in step S47 that the reception for selecting the image data to be transferred to the optical disc and the order thereof ends, in step S49, the user operates the operation key 16 for operation I/F, and the control unit 11 thus determines whether or not an instruction for writing the image data to be transferred to the optical disc is received.

If it is determined in step S49 that the instruction for writing the image data to be transferred to the optical disc is not received, the processing returns to step S44 and the processing after step S44 is thereafter similarly repeated. As a consequence, upon changing and correcting the contents of the data transfer, the user enables the information processing apparatus 1 to iteratively execute the similar processing until obtaining desired contents.

If it is determined in step S49 that the instruction for writing the image data to be transferred to the optical disc is received, in step S50, prior to the data transfer to the optical disc, the control unit 11 recognizes, via the signal bus 15, whether or not a predetermined optical disc is inserted into the optical disc device 19. If it is recognized in step S50 that the predetermined optical disc is not inserted into the optical disc device 19, the control unit 11 enables the display 17 to display a message “Insert a predetermined optical disc into the optical disc device 19”.

If it is recognized that the predetermined optical disc is inserted into the optical disc device 19, the control unit 11 reads, via the signal bus 15, necessary data from the connected portable digital information device, and controls the optical disc device 19 to write the image data to be transferred to the optical disc. The optical disc device 19 writes the image data to be transferred under the control of the control unit 11. Thus, it is possible to backup, to the optical disc, the data (moving image data, still image data, music data, etc.) recorded (stored) to the portable digital information device connected to the information processing apparatus 1.

At this time, depending on the type of the optical disc, writing processing is executed in the standard-format readable/writable by a personal computer, such as ISO 9660 or UDF.

Further, if the image data to be transferred to the optical disc includes the image data of which copyright is protected, the image data is transferred within an available range of the image data having the copyright. Specifically, if only the data shift is possible within the available range, the data is transferred to the optical disc depending on the situation in which the data shift is possible by a preset number of times and the deletion of the image data on the transfer source is executed as needed.

Further, if data encryption is instructed, the data is encrypted and the writing processing is thereafter executed.

Incidentally, when the optical disc device writes the image data to be transferred and the navigation data (including the reproducing control information) to the optical disc, the situation of the data transfer is displayed on the display 17, with bar-graph indication and numeral indication of the estimated end time. As a consequence, the user knows the current situation of the data transfer to the optical disc. Further, upon ending the data transfer to the optical disc, such a message may be informed to the user with a speaker or buzzer (not shown).

Thereafter, the processing returns to the flowchart shown in FIG. 3 and the data creating processing ends.

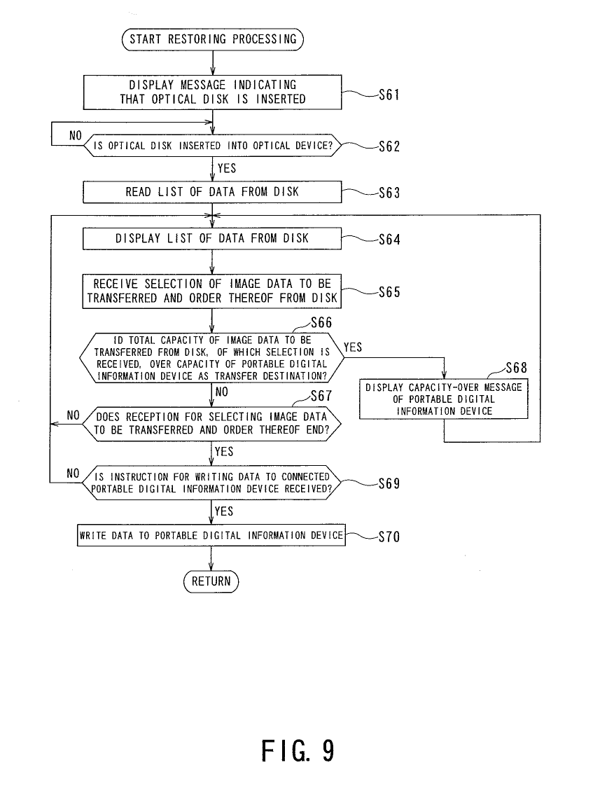

On the other hand, if it is determined in step S41 to receive the instruction for restoring, to another portable digital information device, the data (moving image data, still image data, music data, etc.) recorded (stored) to the portable digital information device connected to the information processing apparatus 1, in step S51, the control unit 11 executes the restoring processing. The details of the restoring processing are shown in a flowchart of FIG. 9.

A description will be given of the details of the restoring processing with the information processing apparatus 1 shown in FIG. 2 with reference to the flowchart of FIG. 9.

In step S61, the control unit 11 enables, via the signal bus 15, the display 17 to display a message for inserting, to the optical disc device 19, the optical disc for backup (the optical disc to which the backup processing has been already executed) that records the data to be restored. The display 17 displays the message for inserting the optical disc that records the data to be restored to the optical disc device 19.

For example, a message of “Insert the disc.” is displayed.

In step S62, the control unit 11 recognizes, via the signal bus 15, whether or not a predetermined optical disc is inserted into the optical disc device 19, and is waited until the predetermined optical disc is inserted into the optical disc device 19.

If it is determined in step S62 that the predetermined optical disc is inserted into the optical disc device 19, in step S63, the control unit 11 controls the optical disc device 19 to read a list of the image data (moving image data and still image data) recorded to the inserted optical disc.

In step S64, the control unit 11 obtains, via the signal bus 15, the list of the image data read from the inserted optical disc, and enables the display 17 to display the obtained list of the image data. The display 17 displays the list of the image data read from the connected portable digital information device under the control of the control unit 11, as shown in FIG. 6. Incidentally, the description of FIG. 6 is basically the same as the contents described in step S15 of FIG. 4 and is omitted so as to prevent the repetition.

In step S65, the user operates the operation key 16 for operation I/F, and the control unit 11 thus receives, via the signal bus 15, the selection of the image data to be transferred to the portable digital information device, serving as the restoring transfer destination, and the order thereof.

In the example shown in FIG. 6, the selection of the icon 23-a or 23-b is received and the selection of the order (e.g., first or second) upon recording the data to the optical disc is simultaneously received. Obviously, at this time, all image data read from the connected portable digital information device can be designated in a lump.

Incidentally, at this time, when the image data is encrypted in the backup processing and is further backuped to the optical disc, upon reproducing the optical disc to which the data is transferred, only when a password of which input is received to a password input receiving column (not shown) matches the preset password, the image data cannot be selected as the transfer target of the portable digital information device. Incidentally, in the recording-prohibiting (read-only) optical disc or the optical disc as an overwriting-type recording medium, the data cannot be deleted in the optical disc on the transfer source after the transfer. Therefore, such a warning message is displayed on the display 17.

In step S66, the control unit 11 determines whether or not the total capacity of the image data to be transferred to the portable digital information device, of which selection is received, is over the capacity of the portable digital information device as the transfer destination.

If it is determined in step S66 that the total capacity of the image data to be transferred to the portable digital information device, of which selection is received, is not over the capacity of the portable digital information device as the transfer destination, in step S67, the control unit 11 determines whether or not the reception for selecting the image data to be transferred to the optical disc and the order thereof ends.

If it is determined in step S67 that the reception for selecting the image data to be transferred to the optical disc and the order thereof does not end, the processing returns to step S64 and the processing after step S64 is iteratively executed. As a consequence, the user can iteratively execute the selection of the image data to be transferred to the optical disc and the order thereof until instructing the end of the reception for selecting the image data to be transferred to the optical disc and the order thereof.

On the other hand, if it is determined in step S66 that the total capacity of the image data to be transferred to the optical disc as the transfer destination, of which selection is received, is over the capacity of the optical disc, in step S68, the control unit 11 enables, via the signal bus 15, the display 17 to display a disc capacity-over warning message serving as a message for warning that the data is over the capacity of the portable digital information device as the transfer destination. Under the control of the control unit 11, the display 17 displays the disc capacity-over warning message serving as the message for warning that the data is over the capacity of the portable digital information device as the transfer destination.

The display 17 displays the message that the capacity is over that of the portable digital information device, e.g., “Capacity of portable digital information device disc is full”.

If it is determined in step S67 that the reception for selecting the image data to be transferred to the optical disc and the order thereof ends, in step S69, the user operates the operation key 16 for operation I/F, and the control unit 11 thus determines whether or not an instruction for writing the image data to be transferred to the portable digital information device is received.

If it is determined in step S69 that the instruction for writing the image data to be transferred to the portable digital information device is not received, the processing returns to step S64 and the processing after step S64 is thereafter similarly repeated. As a consequence, upon changing and correcting the contents of the data to be transferred, the user enables the information processing apparatus 1 to iteratively execute the similar processing until obtaining desired contents.

If it is determined in step S69 that the instruction for writing the image data to be transferred to the optical disc is received, in step S70, the control unit 11 reads, via the signal bus 15, necessary data from the optical disc, and controls the connected portable digital information device to write the image data to be transferred to the portable digital information device. The portable digital information device writes the image data to be transferred under the control of the control unit 11. As a consequence, it is possible to restore the data (moving image data, still image data, music data, etc.) recorded (stored) to the optical disc for backup to the portable digital information device.

Incidentally, if the image data to be transferred to the portable digital information device includes the image data of which copyright is protected, the image data is transferred within the available range of the image data having the copyright. Specifically, if only the data shift is possible depending on the available range, the data is transferred to the portable digital information device depending on the situation in which the data can be shifted by a preset number of times, and the deletion of the image data on the transfer source is executed as needed.

Further, if the data encryption is instructed, the data is encrypted and the writing processing is thereafter executed.

Incidentally, upon writing the image data to be transferred from the optical disc to the portable digital information device, the situation of the data transfer is displayed on the display 17, with bar-graph indication and numeral indication of the estimated end time. As a consequence, the user knows the current situation of the data transfer to the portable digital information device. Further, upon ending the data transfer to the portable digital information device, such a message may be informed to the user with a speaker or buzzer (not shown).

Thereafter, the processing returns to the flowchart shown in FIG. 3, and the data creating processing ends.

According to the first embodiment of the present invention, the identification information for identifying the portable digital information device can be obtained from the portable digital information device connected to the information processing apparatus 1, and it can be determined, by referring to the prestored list table of compatible devices on the basis of the obtained identification information, whether or not the portable digital information device is compatible with the information processing apparatus 1.

Further, if it is determined that the portable digital information device is compatible with the information processing apparatus 1, upon creating the optical disc that can be reproduced by the optical disc play-only device, the navigation data can be created and the image data selected by the user can be written to the optical disc on the basis of the created navigation data (including the reproducing control information).

On the other hand, if it is determined that the portable digital information device is compatible with the information processing apparatus 1, upon creating the optical disc for backup, the image data can be written to the optical disc on the basis of the image data selected by the user.

Further, if it is determined that the portable digital information device is compatible with the information processing apparatus 1, the image data can be written to another portable digital information device with the already-created optical disc for backup on the basis of the image data selected by the user.

Accordingly, the conventional complicated operation via the personal computer is not necessary.

Further, with the optical disc play-only device, the navigation data (i.e., data for creating the menu screen) necessary upon reproducing the data is created. Therefore, the optical disc can be created with disc creating processing, and it is possible to thereafter reproduce the optical disc created by the optical disc play-only device in a house of another user.

Furthermore, it is possible to easily write, to the optical disc, the information recorded (stored) to the connected portable digital information device, irrespective of the type and compatibility of the portable digital information device.

Therefore, it is possible to record the information recorded (stored) to the portable digital information device to the optical disc without the user's consciousness to the difference in portable digital information devices. Moreover, it is possible to improve the convenience upon storing and managing the structure stored in various portable digital information devices.

Incidentally, according to the first embodiment, the data is transferred from the connected portable digital information device to the optical disc. In addition, the data may be copied, shifted, and deleted between the connected portable digital information devices. Alternatively, the data may be copied, shifted, and deleted to a rewritable optical disc.

Further, in order to be compatible with a new portable digital information device, e.g., control information on a new portable digital information device may be obtained from a server (not shown) via a network through a communication unit (not shown) arranged to the information processing apparatus 1, and the list table of compatible devices may be updated on the basis of the obtained control information.

Furthermore, even under the situation in which the information processing apparatus 1 includes a battery and power is not supplied from an external power source via an AC adaptor, the information processing apparatus 1 may be used. As a consequence, the information processing apparatus can be used even without the external power source.

In addition, according to the first embodiment, the display 17 displays various creating screens and messages. However, in place of the display 17, various creating screens and messages may be displayed on an external display device via the video/audio output unit 18.

### Second Embodiment

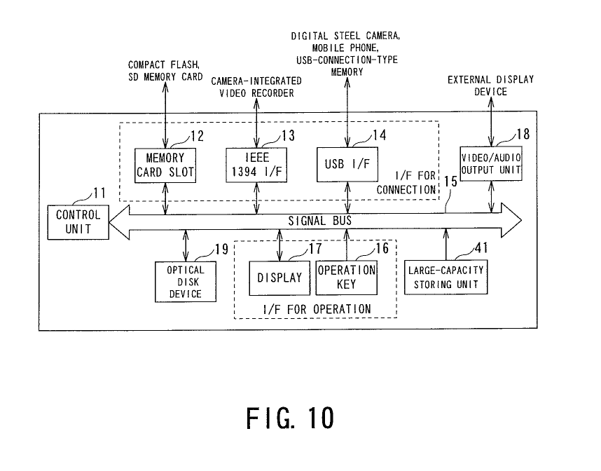

Referring to FIG. 10, the information processing apparatus 1 may further have a large-capacity storing unit 41. The large-capacity storing unit 41 comprises, e.g., a fixing HDD or a large-capacity non-volatile memory (flash memory). Obviously, the large-capacity storing unit 41 may not have a large storage capacity.

Incidentally, the structure of the external view of the information processing apparatus 1 is similar to that shown in FIG. 1, and a description thereof is omitted so as to prevent the repetition.

As a consequence, if the user wants to collect image data that is separately stored to a plurality of memory cards and to create one optical disc (optical disc for backup or optical disc capable of reproduction by an optical disc play-only device), the image data stored in a plurality of memory cards may be temporarily stored in the large-capacity storing unit 41 in the information processing apparatus 1. Thereafter, the information processing apparatus 1 may create one desired optical disc by properly editing the stored image data. Hereinafter, a description will be given of the backup creating processing with the information processing apparatus 1 shown in FIG. 10.

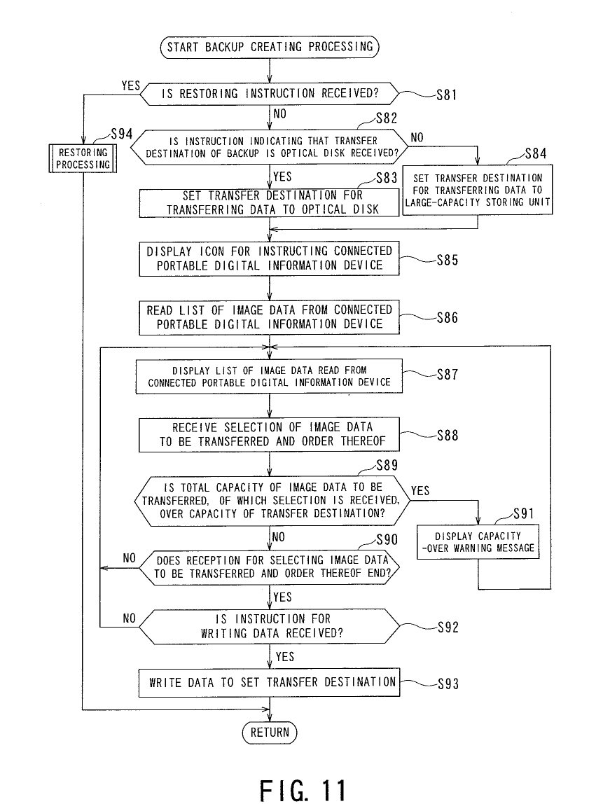

A description will be given of the backup creating processing with the information processing apparatus 1 shown in FIG. 10 with reference to a flowchart shown in FIG. 11. Incidentally, the processing in steps S81 and S85 to S93 of FIG. 11 is basically the same as the processing in steps 41 to S50 of FIG. 8, and a description thereof is omitted so as to prevent the repetition.

If it is not determined in step S81 to receive the instruction for restoring the data (moving image data, still image data, music data, etc.) recorded (stored) to the portable digital information device connected to the information processing apparatus 1 to another portable digital information device (i.e., it is not determined to receive the instruction for backuping, to the optical disc, the data (moving image data, still image data, music data, etc.) recorded (stored) to the portable digital information device connected to the information processing apparatus 1), in step S82, the control unit 11 determines whether or not an instruction that the transfer destination of the backuped data is the optical disc is received.

It is determined in step S82 to receive the instruction that the transfer destination of the backuped data is the optical disc, in step S83, the control unit 11 sets, to the optical disc, the transfer destination for transferring the data (moving image data, still image data, music data, etc.) recorded (stored) to the portable digital information device connected to the information processing apparatus 1.

On the other hand, it is not determined in step S82 to receive the instruction that the transfer destination of the backuped data is the optical disc, in step S84, the control unit 11 sets, to the large-capacity storing unit 41, the transfer destination for transferring the data (moving image data, still image data, music data, etc.) recorded (stored) to the portable digital information device connected to the information processing apparatus 1.

Thereafter, the processing advances to step S85, and the processing after step S85 is executed. As a consequence, the image data, of which selection is received, is written to the optical disc or the large-capacity storing unit 41, as the set transfer destination.

Thus, if the user desires to create the image data separately stored in a plurality of memory cards to one optical disc (optical disc for backup or optical disc readable by an optical disc play-only device) in a lump, the image data stored in a plurality of memory cards is temporarily stored to the large-capacity storing unit 41 in the information processing apparatus 1. Thereafter, the information processing apparatus 1 may create one desired optical disc (e.g., optical disc readable by the optical disc play-only device) by properly editing the stored image data image data.

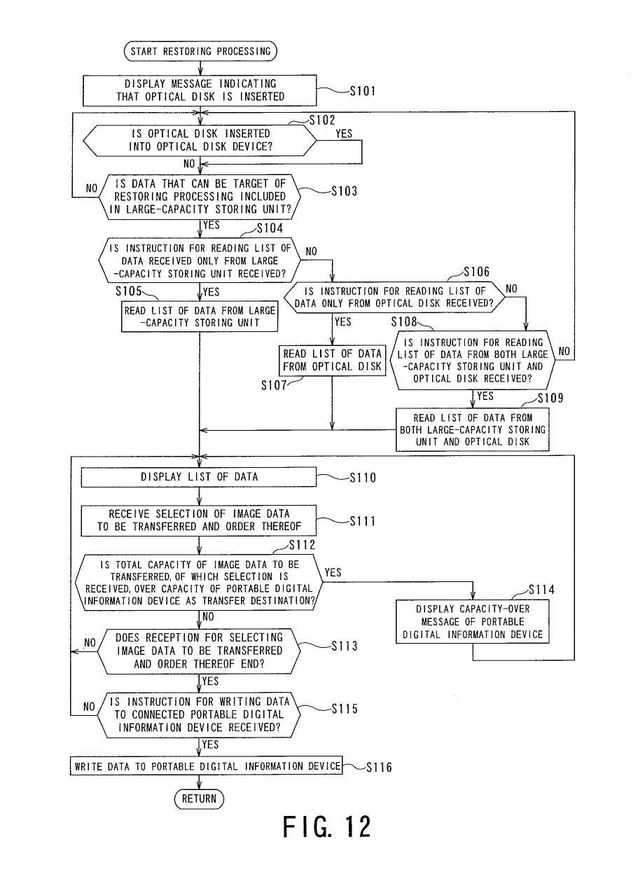

On the other hand, if it is determined in step S81 that the restoring instructing is received, in step S94, the control unit 11 executes the restoring processing. The details of the restoring processing are shown in a flowchart of FIG. 12.

A specific description is given of the restoring processing with the information processing apparatus 1 shown in FIG. 10 with reference to a flowchart of FIG. 12. Incidentally, processing in steps S101 and S110 to S116 in FIG. 12 is basically the same as the processing in steps S61 and S64 to S70 in FIG. 9, and a description thereof is omitted so as to prevent the repetition.

In step S102, the control unit 11 determines, via the signal bus 15, whether or not a predetermined optical disc is inserted into the optical disc device 19. If it is determined in step S102 that the predetermined optical disc is not inserted to the optical disc device 19, in step S103, the control unit 11 determines whether or not the large-capacity storing unit 41 includes data that can be a target of the restoring processing.

If it is determined in step S103 that the large-capacity storing unit 41 does not include the data that can be the target of the restoring processing, the processing returns to step S102 and the processing after step S102 is iteratively executed.

If it is determined in step S102 that the predetermined optical disc is inserted to the optical disc device 19, the processing similarly advances to step S103.

If it is determined in step S103 that the large-capacity storing unit 41 includes the data that can be the target of the restoring processing, in step S104, the user operates the operation key 16 for operation I/F, and the control unit 11 thus determines whether or not an instruction for reading the list of the image data is received only from the large-capacity storing unit 41.

If it is determined in step S104 that the instruction for reading the list of the image data is received only from the large-capacity storing unit 41, in step S105, the control unit 11 reads the list of the image data from the large-capacity storing unit 41. Thereafter, the processing advances to step S110, and processing for writing the image data to the portable digital information device is executed on the basis of the read list of the image data from the large-capacity storing unit 41.

On the other hand, if it is determined in step S104 that the instruction for reading the list of the image data is not received only from the large-capacity storing unit 41, in step S106, the user operates the operation key 16 for operation I/F, and the control unit 11 thus determines whether or not an instruction for reading the list of the image data only from the optical disc is received.

If it is determined in step S106 that the instruction for reading the list of the image data only from the optical disc is received, in step S107, the control unit 11 reads the list of the image data only from the optical disc. Thereafter, the processing advances to step S110, and processing for writing the data to the portable digital information device is executed on the read list of the data only from the optical disc.

If it is determined in step S106 that the instruction for reading the list of the image data only from the optical disc is not received, in step S108, the user operates the operation key 16 for operation I/F, and the control unit 11 thus determines whether or not an instruction for reading the list of the image data from both the large-capacity storing unit 41 and the optical disc is received.

If it is determined in step S108 that the instruction for reading the list of the image data from both the large-capacity storing unit 41 and the optical disc is received, in step S109, the control unit 11 reads the list of the data from both the large-capacity storing unit 41 and the optical disc. Thereafter, the processing advances to step S110, and processing for writing the image data to the portable digital information device is executed on the basis of the read list of the data from both the large-capacity storing unit 41 and the optical disc.

On the other hand, if it is determined in step S108 that the instruction for reading the list of the image data from both the large-capacity storing unit 41 and the optical disc is not received, the processing returns to step S102 and the processing after step S102 is iteratively executed.

Incidentally, various image data and music data obtained from a content server (not shown) connected via a network (not shown) may be stored to the large-capacity storing unit 41 and a background image may be used on a title screen or menu screen by using the stored data.

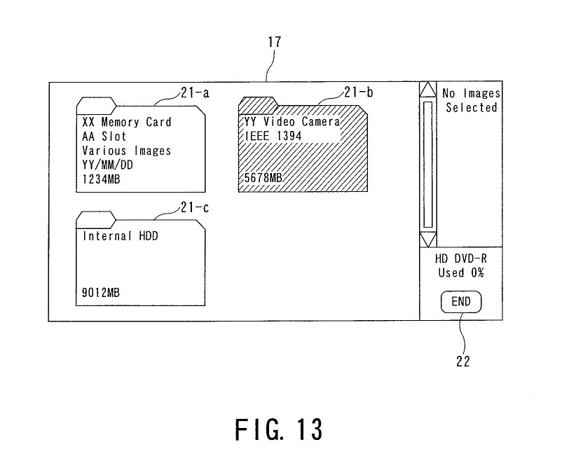

Further, when the large-capacity storing unit 41 is arranged to the information processing apparatus 1, upon displaying the icon indicating the connected portable digital information device, e.g., a screen shown in FIG. 13 is displayed. The display 17 displays icons 21-a and 21-b for instructing the connected portable digital information device and an icon 21-c for instructing the large-capacity storing unit 41.

### Third Embodiment

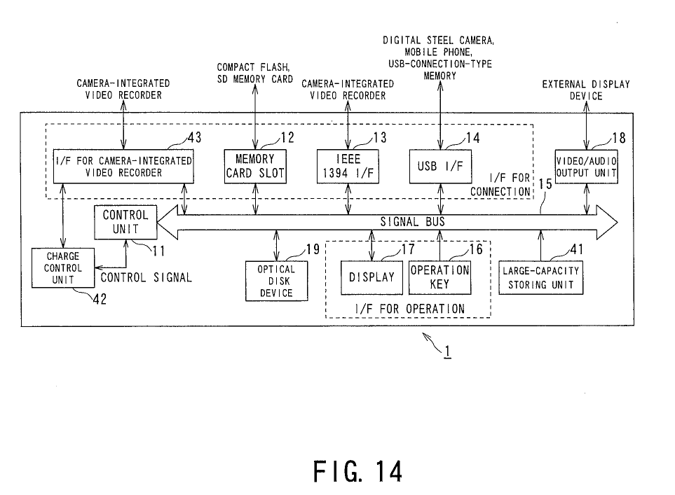

In data communication with a camera-integrated video recorder having no the optical disc as shown in FIG. 14, the information processing apparatus 1 may further have a charge control unit 42 that charges a battery (rechargeable battery) of the camera-integrated video recorder. In this case, in the data communication with the camera-integrated video recorder having no optical disc, the camera-integrated video recorder can also be charged via an I/F 43 for camera-integrated video recorder. As a consequence, it is possible to suppress the troublesomeness of the user required for using preparation of the camera-integrated video recorder.

Obviously, charging processing may be executed in the I/F 43 for camera-integrated video recorder, and data creating processing with the information processing apparatus 1 may be performed via the IEEE 1394 I/F 13. As a consequence, the charge of the camera-integrated video recorder can be executed for a short time. Therefore, it is possible to suppress the troublesomeness of the user required for using preparation of the camera-integrated video recorder.

Incidentally, the icon used according to the third embodiment of the present invention is defined as “instructing information”.

Incidentally, the present invention can be applied not only to the personal computer 1 but also to a PDA, a mobile game device, a mobile music reproducing device, a mobile moving-image reproducing device, and another information processing apparatus.

Further, a series of processing as mentioned according to the embodiments of the present invention can be executed not only by software but also by hardware.

Furthermore, as an example of the processing, steps in the flowcharts are performed on time-series along the described order according to the embodiments of the present invention. However, steps in the flowcharts are not limited to be processed on the time-series and may include processing that is executed in parallel or individually.

What is claimed is:

1. An information processing apparatus comprising:
an obtaining unit configured to obtain identification information for identifying an information device connected to the information processing apparatus from the information device;
a determining unit configured to determine whether or not the information device is compatible with the information processing apparatus based upon a comparison of the identification information with a prestored list of compatible information devices; and
a first writing unit configured to write information that is recorded in advance to the information device to a disc when it is determined that the information device is compatible with the information processing apparatus.

2. The information processing apparatus of claim 1, wherein the identification information comprises at least identification code determined by a connection protocol for each of the information devices, or file structure of the information device.

3. The information processing apparatus of claim 1, further comprising:
an instruction receiving unit configured to receive an instruction for creating a either a backup disc or a disc capable of reproduction by a play-only device when the first writing unit writes the information recorded in advance to the information device to the disc; and
a creating unit configured to create navigation data used upon reproducing the disc by the play-only device when the instruction receiving unit receives the instruction in a case of writing the information recorded in advance to the information device to the disc by the first writing unit.

4. The information processing apparatus according to claim 1, further comprising:
a reading unit configured to read the information from the backup disc to which the information recorded in advance to the information device is written by the first writing unit; and
a second writing unit configured to write the information from the backup disc, read by the reading unit, to another information device.

5. The information processing apparatus according to claim 1, wherein the information device comprises a portable digital information device.

6. An method of information processing in an information processing apparatus, the method comprising:
obtaining identification information from an information device connected to the information processing apparatus;
determining whether or not the information device is compatible with the information processing apparatus based upon the identification information and a prestored list of compatible information devices; and
writing information that is recorded in advance to the information device to a disc when it is determined that the information device is compatible with the information processing apparatus.
